(19) United States
(12) Patent Application Publication
(10) Pub. No.: US 2011/0295770 A1
(43) Pub. Date: Dec. 1, 2011

(54) Solve-A-Crisis

(76) Inventor: Purvish Maheshbhai Mehta, (US)

(21) Appl. No.: 12/800,921

(22) Filed: May 26, 2010

(51) Int. Cl. G06Q 90/00

(52) U.S. Cl. 705/500

(57) ABSTRACT

To reduce a chunk of the 2.3 trillion a year healthcare cost in the U.S. Solve-A-Crisis is a floating vessel/ship/very large floating platform equipped with a fully functional hospital (which is run by a contracted JCI accredited hospital) standing in international waters, which is also a preferred surgical hospital by the U.S. insurance companies. Surgeries/Procedures performed at Solve-A-Crisis will be at the rates of non U.S. international JCI accredited hospitals but will be paid for by the U.S. insurance companies. Surgeries outside the United States typically cost at around 20-50% of those performed in the U.S. Out of the 50-80% money saved in getting surgery on board the ship, the patient will receive a bonus check of a percentage ranging from 10-50% of the cost difference. That way the total healthcare bill comes down to about 50-70%. Saving the U.S. trillions every year.

Everybody has an incentive; The U.S. private insurance companies will not put any investment on this venture, but will be a 25% partner in the net proceeds. Also the U.S. government will be a similar 10% partner in the net proceeds.

Small example—a procedure cost $10,000 to the Insurance Company in the U.S. hospital and the patient has a co-pay ranging from 0 to 2000 dollars. Let's say it cost $2000 on board the Solve-A-Crisis. Patient agrees to get the surgery on board the Solve-A-Crisis, Solve-A-Crisis gets reimbursed $3000 from the U.S. insurance company. It gives the standard rate of $2000 to the contracted JCI hospital working on board. From the net profit of $1000, $250 is passed to the Insurance company and $100 to the U.S. Government. The insurance company still saves $5000 and passes on a percentage of that to the patient as an incentive to get surgery on the ship.

Remember, the primary target is the market segment of people who have good insurance and are covered, unlike other medical tourism projects that target the un-insured and the under-insured who do not have a choice but to get healthcare abroad. If that market segment follows, they are welcome as well.

The reason for involving the U.S. govt is explained later.

### DESCRIPTION

JCAHO stands for joint commission on Accreditation of Healthcare Organizations, which is the organization that governs all the U.S. hospitals. The JCI stands for joint commission international which endorses hospitals outside the U.S. and confirms that they are equal or above the U.S. hospital standards. JCI is a wing that operates under the JCAHO. There are several JCI hospitals outside the U.S. in various countries that already cater to the U.S. patient or customer. Apollo hospitals in India are one such example. We will contract with such JCI hospitals to deliver healthcare. We would also contract on the other hand with private U.S. insurance companies to bring customers to us.

The U.S. healthcare system is currently broke. Even after the healthcare bill passage in 2014 things are poised to make it worse. Sooner or later outsourcing healthcare will be the only option at least to a certain degree or percentage. This is where we fit in. The outsourcing boom will happen between 2014 to 2020. Also currently there is a shortage of 100,000 doctors in the U.S., with only 25,000 doctors graduating every year.

### SPECIFICATION

### Whole Project has been Put in the in the Manner of a Business Plan

### Objective

Because of the magnitude of the project the objectives are broken down into step-by-step processes

A. within the first year
to have the MOU(memorandum of understanding) put down between Solve-A-Crisis and the U.S. insurance companies
to have a MOU put down between Solve-a-Crisis and Apollo hospitals (foreign JCI hospital)
To have a cost analysis statement for the actual cost to build one platform and also the timeframe required to build.
To notify and involve the U.S. government of the project

B. After the initial objectives are taken care of
to have one platform up and running
Also customize a secondary smaller vessel to take care of the transportation of personnel and equipment to and from Solve-a-Crisis and Apollo.
Also add a line of transportation vehicles for the customers. Initially local ferry services will be contracted to serve the purpose.
Multiple platforms/ships to be positioned near the east and west coasts in future.

Keys to Success
cost-effective
convenience
the final and ultimate solution to cost control the U.S. health system

Services

Those will be equal to that of a typical hospital except
it will handle no emergencies
it will handle no highly skilled operations like cardiovascular or neuro-surgeries
services costing less than $5000 won't be feasible to handle
Surgeries above 25000 $ can afford to pay for the patients transportation costs.
   Primary Target Will be in this Following Sections

General surgeries, fertility, cancer treatments, MRI's, cosmetics, dental, nursing homes/home healthcare and all those which have big differences in the U.S. and non U.S. hospital costs.

This is a typical comparison of some procedures from an online website.

| Medical Procedure | U.S.A | Mexico | Cost Rica | India | Thailand | Korea |
|---|---|---|---|---|---|---|
| Angioplasty | Up to $57,000 | $17,100 | $14,000 | $10,000 | $9,000 | $21,600 |
| Heart Bypass | Up to $144,000 | $21,100 | $26,000 | $10,000 | $26,000 | $26,000 |
| Heart Valve Replacement | Up to $170,000 | $31,000 | $31,000 | $3,000 | $24,000 | $38,000 |
| Knee Replacement | Up to $50,000 | $11,500 | $12,000 | $9,000 | $14,000 | $19,800 |
| Hip Resurfacing | Up to $30,000+ | $13,400 | $13,000 | $10,000 | $18,000 | $22,900 |
| Hip Replacement | Up to $43,000 | $13,800 | $13,000 | $10,000 | $16,000 | $18,450 |
| Special Fusion | Up to $100,000 | $8,000 | $16,000 | $14,000 | $13,000 | $19,350 |
| Face Lift | Up to $15,000 | $8,000 | $6,500 | $9,000 | $8,600 | $5,000 |
| Breast Implants | Up to $10,000 | $9,000 | $4,000 | $6,500 | $5,700 | $13,600 |
| Rhino Plasty | Up to $8,000 | $5,000 | $6,000 | $5,500 | $5,400 | $6,000 |
| Lap Band/Bariatric | Up to $30,000 | $9,200 | $9,000 | $9,500 | $14,000 | $11,500 |
| Hysterectomy | Up to $15,000 | $7,500 | $6,000 | $7,500 | $7,000 | $11,000 |
| Dental Implant | Up to $2,000-10,000 | $1,000 | $1,100 | $1,000 | $1,000 | $2,000 |

### Funding

Initially it will be a venture capital funded program, however, because of the magnitude of the project, it will a requirement to set up a group of several venture capitalists functioning as a mutual fund for the project, Floating platforms on waters are known to cost in the vicinity of 400-1000 $ per square foot. Even if we start the first platform with a small 100 bed hospital it would require high capital.

### Management and Personnel

All the front end staff is proposed to be Employees from the U.S. neighboring states, that will serve to build a good repor between the hospital and the patients,

All the medical staff of course will be the foreign hospital staff.

### Sales Statistics

The business is on of which does not require to build a market, it already exists, What's more, everybody is in the pie to make some dough. The project, the contracted JCI, The U.S. insurance (private or government), and also the patient.

Also, once the project starts rolling, it will move on to specialized surgeries, calling doctors on occasional basis on and off for some months a year to perform.

Word of mouth satisfaction, testimonials advertised, and reviews from JCAHO as well as patients can only bring in increased business. In some cases of increased business, it means decrease in quality, but that is never going to happen here because we have a number of hospitals to get contracted to run that particular department.

### THE NORMAL PROCESS IN DETAIL

Once the customer is pre-approved for a surgical procedure from the insurance company it gets a letter from the insurance company stating that if the customer of the patient chooses the option to have the surgery done outside the U.S. hospital on the platform (Solve-a-crisis), he will receive a so-and-so bonus check and also because of the dollar amount saved on the total procedure he won't be using that much of this yearly allocated funds on his healthcare insurance.

After that if the customer chooses so, he or she then contacts us. The patient is given a list of options from the hospitals which are currently contracted with us. That will show the details of how many procedures of particular hospital which is JCI accredited, has done for that particular surgical procedure, and how it ranks for that procedure as well as reviews and testimonials from U.S. customers who have already been operated under them.

Once the patient decides on which hospital to go through, they are set up with an appointment for the procedure. We then notify the patient's insurance company of the details and the surgery is performed, upon leaving or reaching home the patient receives a nice bonus check is a gift from us or their insurance however it is negotiated. That way the patient doesn't see its insurance company is the only benefactor in the process.

There is no waiting or a lag time to get the procedure done, because we already have a 24/7 hospital with various departments operating all the time. Because of the volume of business supplied by the Insurance companies, we will not need to set up any postponed dates for the procedure. It will be more like a walk-in-clinic for surgeries.

The same process can work for the patient who doesn't have insurance, or whose insurance doesn't cover the surgical process, or a patient simply paying cash without insurance.

### SUMMARY

A non U.S. doctor cannot perform surgery or provide healthcare anywhere on land in the United States, A doctor from India/Thailand cannot perform in the U.S. or the neighboring countries such as Mexico or Canada, There is however no restriction on providing healthcare in international waters. Already I.T companies and casinos operate in seas without the restrictions of a particular country. The same can be applied for hospitals standing in international waters, what's more, we are going to build one that is tailor made to serve the United States.

1. National expenditure of U.S. healthcare according to 2008 data is $2.3 trillion, 51% of which goes to hospital care and physician or clinical services

2. According to a study done by Deloitte Center for Health Solutions, an estimated 750,000 Americans traveled abroad for medical care in 2007. This number is expected to increase to six million in 2010. (These are people who are underinsured or noninsured)

3. After the healthcare bill passage shortage of healthcare is about to increase, the lack or appointment times to see doctors is about to increase even if the cost is cut down, the accessibility to care or doctors or hospitals is about to increase
After the passage of the bill, it was easy for the federal government to pass coverage to 32 million more Americans however if 15 million (projected data) of them end up getting Medicaid, the burden is going to the individual states not to the federal. The states Medicaid for many is already bankrupt and according to the new law, after 2014 through 2020, federal government will cover the additional cost of the new sign-ups but after 2020, only 90% will be covered by federal and 10% still remains to be covered through the individual states.

4. Typically only a small portion of the total healthcare is taken by the medical tourism business, but this project will target the major chunk of the business, i.e. to get through the U.S. Insurance private companies like Blue Cross Blue Shield, Aetna, and CIGNA and so on.

5. The ship will have a hospital on board that has several contracted hospitals from various different countries functioning on the ship. That way the U.S. patient or customer is given a choice from a list of options with whom to have the surgery performed. Initially we might be working with only one contractor.

6. The U.S. government is made up 10% partner only for the following reasons After several years of functioning and catering to the U.S. insurance companies and creating a trustworthiness to the U.S. customer, we will then try to contract with the state's individual Medicaid plans likewise the private insurance companies. Also it will be much easier to negotiate a docking area for the floating vessel to be as close to the U.S. coastal area as possible so that commute times are shorted and transportation costs are minimized
It is a known fact that the state Medicaid programs do not cover medication drugs that are not considered on their rebate program, which means that for every drug that cover they get a kick-back from that particular drug manufacturer. That is a clear indication which is positive ensuring that it won't be difficult to contract with the U.S. government in this matter.

7. Initially a ferry or helicopter service will be contracted to move patients to and from the U.S. coast to the ship.

8. Support to claim 5, the major reputed JCI accredited on hospitals will be contacted and deals will be negotiated so as to get a group discount on the surgeries. The top 2 to 3 hospitals will be contracted to perform on ship at the rates contracted. Mostly this hospitals have doctors graduated from the U.S. and UK and have already performed surgeries on foreign tourists visiting for medical purposes.
This way not only does the U.S. customer not have to travel abroad but can also choose from a variety of different hospitals.

9. In support to claim 4, there will be no need to find a market for this project because private insurance companies who are indirect partners in the project (not administrative, only fiscal) will be taking care of that part.

10. Before start of the whole project, there will be a MOU (memorandum of understanding) discussed between both the private insurances and the contracting hospital.

11. In support of claim 10, the MOU between Solve-A-Crisis and the contracted hospital will have the following details
Allocation of the charges applied for various procedures
Various dedicated brackets for the costs that is for example
1-100 operations per year would be 100% of contracted costs
100-500 operations would be 80% of contract costs and so on
List the doctors who will be operating—must be from a current JCI hospital

12. In support of claim 10, the MOU between Solve-A-Crisis and the insurance company will have the following details
We are involving multiple insurance companies
Details of the proceeds being passed on to one's insurance and to patients
Details of the maximum and minimum for proceeds supposed to be given out
The deal to show details of the contract between the contracted JCI and Solve-A-Crisis
